(19) United States
(12) Patent Application Publication
(10) Pub. No.: US 2010/0156291 A1
(43) Pub. Date: Jun. 24, 2010

(54) PLASMA DISPLAY PANEL

(75) Inventors: Sang-Yeol HUR, Suwon-si (KR); Myun-Gi Shim, Suwon-si (KR); Dong-Gun Moon, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/624,766

(22) Filed: Nov. 24, 2009

(30) Foreign Application Priority Data
Dec. 22, 2008 (KR) 10-2008-0131194

(51) Int. Cl. H01J 17/49

(52) U.S. Cl. 313/583

(57) ABSTRACT

A plasma display panel including a substrate, a plurality of discharge electrodes arranged on the substrate, a dielectric layer covering the discharge electrodes, and a dielectric band covering the ends of terminal portions of the discharge electrodes, which are not covered by the dielectric layer.

### CROSS-REFERENCE TO RELATED APPLICATION

This application claims the benefit of Korean Application No. 10-2008-131194, filed Dec. 22, 2008, in the Korean Intellectual Property Office, the disclosure of which is incorporated herein, by reference.

### BACKGROUND OF THE INVENTION

1. Field of the Invention

Aspects of the present invention relate to a plasma display panel (PDP).

2. Description of the Related Art

In general, PDPs are flat display devices for displaying images, by discharging a discharge gas injected between two opposing substrates, on which a plurality of discharge electrodes are arranged. The discharge gas emits ultra violet rays, which excite a phosphor material in a phosphor layer, to produce the images.

A conventional 3-electrode surface discharge PDP includes: a first substrate; an opposing second substrate; discharge and sustain electrode pairs (X and Y electrode pairs) formed on an inner surface of the first substrate; a first dielectric layer covering the electrode pairs; a protection layer formed on the surface of the first dielectric layer; address electrodes formed on an inner surface of the second substrate and extending across the electrode pairs, a second dielectric layer covering the address electrode; a partition wall installed between the first and second substrates; red, green, and blue phosphor layers formed on an inner surface of the partition wall; and a discharge gas injected between the first and second substrates. The electrode pairs and address electrodes are grouped at edges of the first and second substrates, such that terminals of each discharge electrode are connected to terminals of a signal transmission unit.

In the conventional PDP, electric signals are applied to the Y electrodes and the address electrodes to select discharge cells. The electric signals are alternately applied to the X and Y electrodes, to generate surface discharges on the surface of the first substrate, so that ultraviolet rays are generated. Visible light is emitted from the phosphor layers of the selected discharge cells, in order to display an image. However, the conventional PDP has the following disadvantages.

The discharge electrodes are patterned using a printing method, which includes using a conductive material, such as a silver (Ag) paste. However, when the silver is ionized by moisture, a short-circuit is generated between terminal portions of the adjoining discharge electrodes, resulting in the formation of line defects in an image.

A method of patterning a discharge electrode using a deposition method is currently under development. However, according to this method, during a curing process ends of terminal portions of discharge electrodes may be separated from a substrate, due to a weak connection between the substrate and the terminal portions of the discharge electrodes.

### SUMMARY OF THE INVENTION

Aspects of the present invention provide a plasma display panel (PDP), in which a terminal portion of a discharge electrode and substrate are maintained in close contact with each other, by forming a dielectric band at an end of the terminal portion. The dielectric band prevents the terminal portion from being separated from the substrate, during a curing process.

According to an aspect of the present invention, there is provided a plasma display panel including a substrate, a plurality of discharge electrodes arranged on the substrate, and a dielectric layer in which the discharge electrodes are buried. Dielectric bands are formed to cover ends of the terminal portions.

According to another aspect of the present invention, there is provided a plasma display panel including: a substrate having a display area to display an image, and a non-display area extending from an edge of the display area; discharge electrodes arranged on the substrate, each having a discharge portion, a connection portion extending from the discharge portion, and a terminal portion extending from the connection portions and connected to an external terminal; and a dielectric layer in which the discharge electrodes are buried. One or more dielectric bands are formed as lines that cover the ends of the terminal portions.

According to another aspect of the present invention, there is provided a plasma display panel including: a substrate having a display area to display an image, and a non-display area extending from an edge of the display area; discharge electrodes extending from the display area to the non-display area; a dielectric layer covering the discharge electrodes, except for terminal portions of the discharge electrodes; and one or more dielectric bands to cover the ends of the terminal portions.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings, of which:

FIG. 1 is a partially cut-away, exploded perspective view of a PDP, according to an exemplary embodiment of the present invention;

FIG. 2 is a plan view illustrating a pattern of discharge electrodes, according to an exemplary embodiment of the present invention; and

FIG. 3 illustrates a group of the discharge electrodes of FIG. 2.

### DETAILED DESCRIPTION OF THE EXEMPLARY EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures.

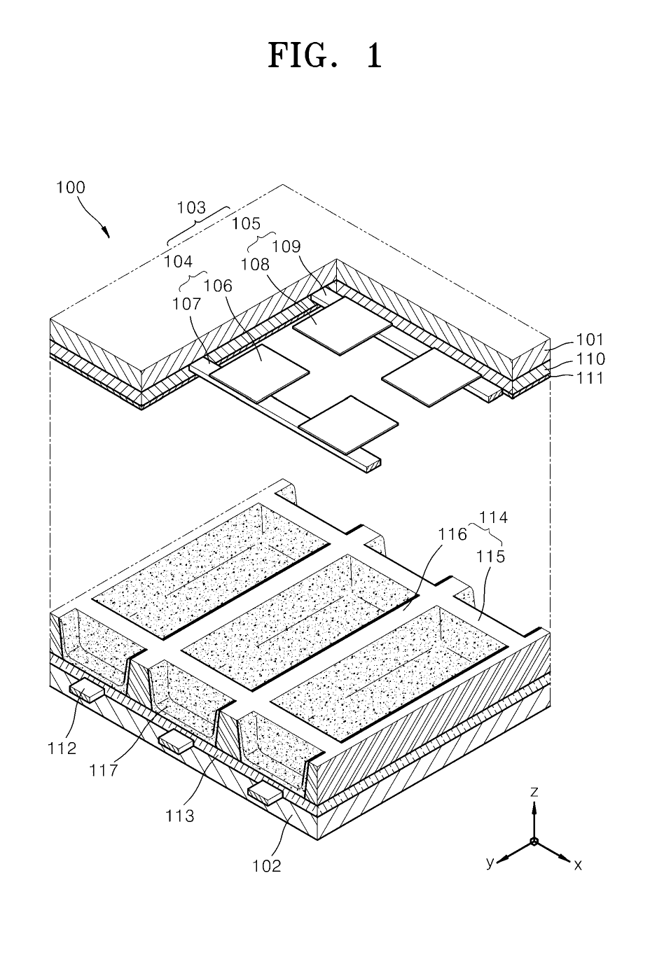

FIG. 1 is a partially cut-away, exploded perspective view of a PDP 100, according to an exemplary embodiment of the present invention. Referring to FIG. 1, the PDP 100 includes a first substrate 101 and a second substrate 102 that is arranged parallel to the first substrate 101. Frit glass (not shown) is coated on the opposing edges of the inner surfaces of the first and second substrates 101 and 102, to form a sealed discharge space.

The first substrate 101 may be formed of a transparent substrate, such as soda lime glass substrate, a semi-transparent substrate, a reflective substrate, or a colored substrate. Discharge and sustain electrode pairs 103 are arranged on the inner surface of the first substrate 101. Each electrode pair 103 includes an X electrode 104 and a Y electrode 105.

The X electrode 104 includes X transparent electrodes 106 independently arranged in discharge cells of the PDP 100, and an X bus electrode line 107 extending along the discharge cells in the X direction and electrically connecting the X transparent electrodes 106. The Y electrode 105 includes Y transparent electrodes 108 independently arranged in the discharge cells of the PDP 100, and a Y bus electrode line 109 extending along the discharge cells in the X direction and electrically connecting the Y transparent electrodes 108.

The X transparent electrodes 106 and the Y transparent electrodes 108 each have a rectangular shape and are spaced apart from each other at the center of each discharge cell, by a discharge gap. The X bus electrode line 107 and the Y bus electrode line 109 extend along opposing edges of the discharge cells, in strips.

The X transparent electrodes 106 and the Y transparent electrodes 108 are each formed of a transparent conductive film, such as an ITO film. The X bus electrode line 107 and the Y bus electrode line 109 are each formed of a conductive Ag paste, or a metallic material such as chrome-copper-chrome. The X electrode 104 and the Y electrode 105 are buried (covered) in a first dielectric layer 110. The first dielectric layer 110 is a coated transparent dielectric material, for example, a high-dielectric material such as PbO—B₂O₃—SiO₂.

A protection layer 111 formed of MgO is deposited on the surface of the first dielectric layer 110, to increase the emission of secondary electrons. The second substrate 102 may be a transparent substrate, a semi-transparent substrate, a reflective substrate, or a colored substrate.

Address electrodes 112 are formed on the inner surface of the second substrate 102 and extend across the Y electrodes 105. The address electrodes 112 are strips that extend across the discharge cells, in the Y direction. The address electrodes 112 are buried (covered) in a second dielectric layer 113.

A partition wall 114 is arranged between the first and second substrates 101 and 102, to at least partially define the discharge cells and prevent crosstalk between adjacent discharge cells. The partition wall 114 includes first partition walls 115 arranged in the X direction and second partition walls 116 arranged in the Y direction. The first partition walls 115 and the second partition walls 116 are coupled together in a lattice pattern. The partition wall 114 is not limited to the above-descried structure, and any structure capable of dividing the discharge cells may be employed. Accordingly, the discharge cells may have various shapes, including polygonal, circular, ovoid, or rectangular.

A discharge gas, such as Ne—Xe, or He—Xe, is injected into the discharge cells, between the first substrate 101, the second substrate 102, and the partition wall 114. A phosphor layer 117 is formed in the discharge cells. The phosphor layer 117 emits visible light, when excited by ultraviolet light generated by the discharge gas. The phosphor layer 117 may be coated in any area of the discharge cells, such as the upper surface of the second dielectric layer 113 and the inner surfaces of the partition wall 114.

The phosphor layer 117 can include red, green, and blue phosphor layers, but is not limited thereto. In the present exemplary embodiment, the red, green, and blue phosphor layers are, respectively, formed of (Y,Gd)BO₃:Eu⁺³, Zn₂SiO₄:Mn²⁺, and BaMgAl₁₀O₁₇:Eu²⁺. The electrode pairs 103 and/or the address electrodes 112 are patterned through a deposition process. Dielectric bands are formed at the ends of the terminal portions of the electrode pairs 103 and/or at the ends of the terminal portions of the address electrodes 112.

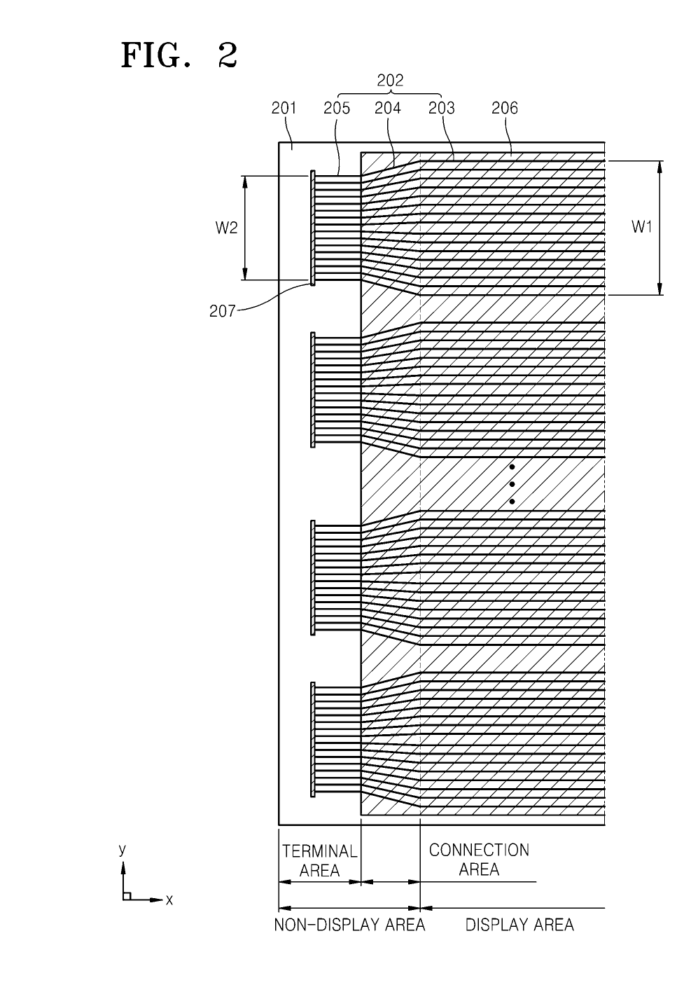

FIG. 2 is a plan view illustrating discharge electrodes 202, according to an exemplary embodiment of the present invention. The discharge electrodes 202 may represent the X electrodes 104, the Y electrodes 105, and/or the address electrodes 112. Referring to FIG. 2, the discharge electrodes 202 are arranged on a substrate 201. The discharge electrodes 202 are formed as strips that extend in the X direction and are separated from one another in the Y direction.

The substrate 201 includes a display area and a non-display area disposed at an edge of the display area. The non-display area includes a connection area and a terminal area. Each of the discharge electrodes 202 includes a discharge portion 203, a connection portion 204 extending from the discharge portion 203, and a terminal portion 205 extending from the connection portion 204, which can be connected to an external terminal (not shown).

The discharge portions 203 are arranged in the display area. The connection portions 204 are arranged in a connection area disposed at the edge of the display area. The terminal portions 205 are arranged in a terminal area extending from the connection area to the edge of the substrate 201. The distance between connection portions 204 is reduced from the discharge portions 203 to the terminal portions 205. The discharge portion 203, the connection portion 204, and the terminal portion 205 are integrally connected, throughout the display area, the connection area, and the terminal area.

The discharge electrodes 202 are arranged in groups. In each group, the terminal portions 205 of the discharge electrodes are electrically connected to external connecters, for example, the terminals of flexible printed cables. In each group, the overall width W1 of the discharge portions 203 is greater than the overall width W2 of the terminal portions 205.

The discharge portions 203 and the connection portions 204 are buried in the first dielectric layer 206. The first dielectric layer 206 is coated over the entire surfaces of the display area and the connection area of the substrate 201, thus covering the discharge portions 203 and the connection portions 204. Alternatively, the first dielectric layer 206 may be selectively formed only on the discharge portions 203 and the connection portions 204. In each group, a dielectric band 207 is disposed on the ends of the terminal portions 205. The ends of the terminal portions 205 are not disposed adjacent to the connection portions 204 and can be referred to as free ends of the terminal portions 205.

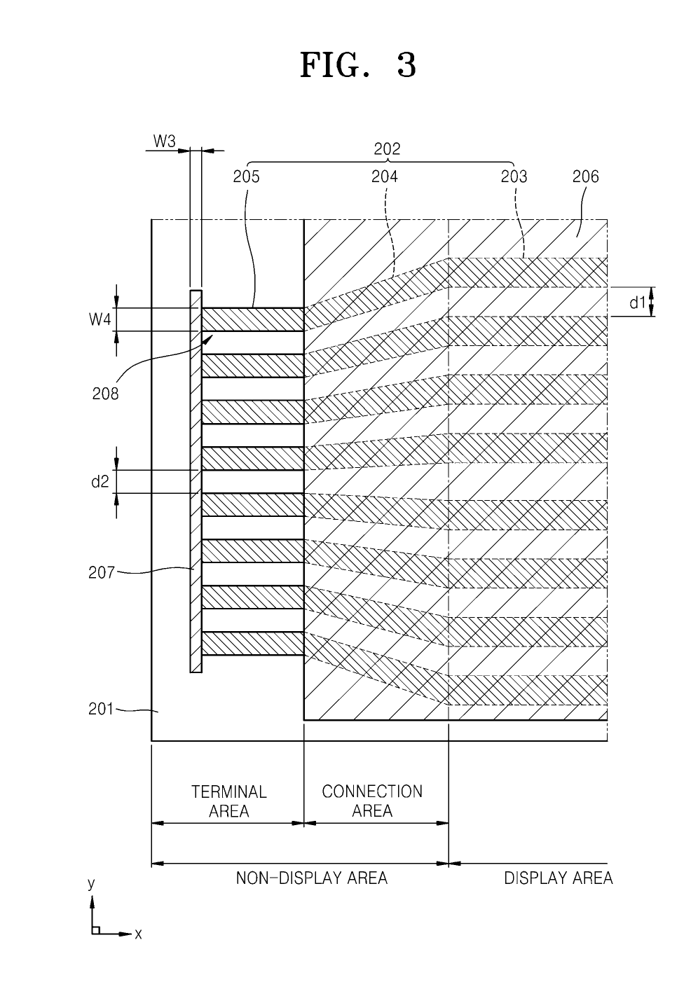

FIG. 3 illustrates one of the groups of discharge electrodes 202 of FIG. 2. Referring to FIG. 3, each of the discharge electrodes 202 includes the discharge portion 203, which is arranged in the display area, the connection portion 204, which is arranged in the connection area and extends from the discharge portion 203, and the terminal portion 205, which is arranged in the terminal area and extends from the connection portion 204. The discharge electrodes 202 are formed of a highly conductive metallic material, such as aluminum, nickel, or silver. Each of the discharge electrodes 202 is patterned using a deposition method, to a thickness of from about 5-6 μm.

In the group of discharge electrodes 202, the distance d1 between the adjacent discharge portions 203 is greater than the distance d2 between the adjacent terminal portions 205. This is because the distance between the connection portions 204 is gradually reduced in the connection area. Accordingly, by decreasing the overall width W2 of the terminal portions 205 of FIG. 2, the size of an external connector (not shown), such as a flexible printed cable that is electrically connected to the terminal portions 205, may be reduced.

The dielectric band 207 is installed at ends 208 (free ends) of the terminal portions 205. The dielectric band 207 is installed to fix the ends 208 of the terminal portions 205, so that the ends 208 are not separated from the substrate 201, during curing. The external connector is electrically connected to exposed areas of the terminal portions 205, between the dielectric band 207 and the dielectric layer 206.

The dielectric band 207 is formed separately from the first dielectric layer 206, in which the discharge portion 203 and the connection portion 204 are buried. The dielectric band 207 covers the ends 208 of the terminal portions 205, and extends linearly in the Y direction.

Although in the present exemplary embodiment the ends 208 of the terminal portions 205 in each group are covered by a separate dielectric band 207, the present invention is not limited to the above-describe shape, and any structure capable of covering the ends 208 may be employed. For example, a single strip-shaped dielectric band can be used to cover the ends 208 of several different groups.

The width W3 of the dielectric band 207 is generally greater than about 100 μm and less than about 50% of the width W4 of the terminal portions 205. If the width W3 of the dielectric band 207 is less than about 100 μm, the ends 208 may become separated from the substrate 201. If the width W3 of the dielectric band 207 is greater than 50% of the width W4 of the terminal portions 205, there may be insufficient space to connect the terminal portions 205 to the external connector.

The dielectric band 207 is generally formed of substantially the same material as the first dielectric layer 206, for convenience of a manufacturing process. However, the present invention is not limited thereto, and any adhesive material capable of preventing the separation of the ends 208 from the substrate 201, during the curing process, may be employed.

The process of manufacturing the dielectric band 207 is described below, with reference to FIGS. 2 and 3. First, an aluminum layer, having a thickness of 5-6 μm, is deposited on the substrate 201. Next, the discharge electrodes 202 are patterned by exposure, development, and etching processes. The discharge electrodes 202 each include the discharge portion 203 arranged in the display area, the connection portion 204 arranged in the connection area and extending from the discharge portion 203, and the terminal portion 205 arranged in the terminal area and extending from the connection portion 204.

The first dielectric layer 206 is printed on the substrate 201. Accordingly, the first dielectric layer 206 is formed throughout the display area and the connection area of the substrate 201, to bury (cover) the discharge portions 203 and the connection portions 204. The dielectric bands 207 are formed at the ends 208 of the terminal portions 205, and are spaced apart from the first dielectric layer 206. The dielectric bands 207 and the first dielectric layer 206 may be formed at the same time to simplify the manufacturing process, but the present invention is not limited thereto.

The dielectric bands 207 are patterned for each of the groups of discharge electrodes 202. The width W3 of the dielectric bands 207 is greater than about 100 μm and less than about 50% of the width W4 of each of the terminal portions 205.

Next, a curing process is performed. The dielectric bands 207 prevent the ends 208 of the terminal portions 205 from being separated from the substrate 201, due to the characteristics of the dielectric material. Thus, the close contact between the substrate 201 and the terminal portions 205 is firmly maintained.

As described above, in a PDP according to the exemplary embodiment of the present invention, since a dielectric band portion patterned to fix the ends of the terminal portions, the ends of the terminal portions are prevented from being separated from the substrate, during curing. Thus, the discharge electrodes are prevented from detaching from the substrate.

Also, since a pretreatment process, to improve the attachment of the discharge electrode to the substrate, is omitted, the manufacturing process may be simplified. Furthermore, since the development of a material for a discharge electrode exhibiting a high contact property is not needed, the manufacturing costs may be reduced.

Although a few exemplary embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. A plasma display panel comprising:
a substrate;
a group of discharge electrodes arranged on the substrate, the discharge electrodes each having a terminal portion, a connection portion extending from the terminal portion, and a discharge portion extending from the terminal connection portion;
a dielectric layer covering the connection portions and the discharge portions; and
a dielectric band covering the ends of the terminal portions.

2. The plasma display panel of claim 1, further comprising:
a plurality of the groups; and
a plurality of the dielectric bands,
wherein each of the dielectric bands is a separate strip that covers the ends of the terminal portions of one of the groups.

3. The plasma display panel of claim 1, further comprising a plurality of the groups, wherein the dielectric band is a strip that covers the ends of the terminal portions of all of the groups.

4. The plasma display panel of claim 1, wherein the width of the dielectric band is greater than about 100 μm and less than about 50% of the width of the terminal portion of each of the discharge electrodes.

5. The plasma display panel of claim 1, wherein the discharge electrodes are formed by patterning a deposited metallic material.

6. A plasma display panel comprising:
a substrate having a display area to display an image and a non-display area extending from an edge of the display area;
a group of discharge electrodes arranged on the substrate, the electrodes each having a discharge portion, a connection portion extending from the discharge portion, and a terminal portion extending from the connection portions;
a dielectric layer covering the discharge electrodes; and
a dielectric band covering the ends of the terminal portions.

7. The plasma display panel of claim 6, wherein:
the non-display area is divided into a connection area extending from the display area, and a terminal area extending from the connection area to an edge of the substrate; and
the discharge portions, the connection portions, and the terminal portions are respectively arranged in the display area, the connection area, and the terminal area.

8. The plasma display panel of claim 7, the width of the group of discharge electrodes is at a maximum at the discharge portions and is at a minimum at the terminal portions.

9. The plasma display panel of claim 7, further comprising:
a plurality of the groups of discharge electrodes; and
a plurality of the dielectric bands,
wherein each of the dielectric bands covers the ends of the terminal portions of one of the groups.

10. The plasma display panel of claim 7, further comprising a plurality of the groups of discharge electrodes, wherein the dielectric band is a strip that covers the ends of the discharge electrodes in all of the groups.

11. The plasma display panel of claim 6, wherein the dielectric layer covers the discharge portions and the connection portions.

12. The plasma display panel of claim 6, wherein the width of the dielectric band is greater than 100 μm and less than 50% of the width of the terminal portion of each of the discharge electrodes.

13. The plasma display panel of claim 6, wherein the discharge electrodes are formed by patterning a deposited metallic material.

14. A plasma display panel comprising:
a substrate having a display area to display an image and a non-display area extending from an edge of the display area;
discharge electrodes extending from the display area to the non-display area;
a dielectric layer covering the discharge electrodes, except for terminal portions of the discharge electrodes; and
a dielectric band covering the ends of the terminal portions, the dielectric band being separated from the dielectric layer.

15. The plasma display panel of claim 14, wherein the dielectric band extends in a line that is generally perpendicular to a long axis of the discharge electrodes.

16. The plasma display panel of claim 14, wherein an external connection is electrically connected to the terminal portions, between the dielectric band and the dielectric layer.

17. The plasma display panel of claim 14, wherein the width of the dielectric band is greater than 100 μm and less than 50% of the width of each of the terminal portions.

18. The plasma display panel of claim 14, wherein the discharge electrodes are formed by patterning a deposited metallic material.

19. The plasma display panel of claim 1, wherein the ends of the terminal portions are distal to the connection portions.

20. The plasma display panel of claim 6, wherein the ends of the terminal portions are distal to the connection portions.
